(19) United States
(12) Patent Application Publication
(10) Pub. No.: US 2023/0281466 A1
(43) Pub. Date: Sep. 7, 2023

(54) AUTONOMOUS GENERATION, DEPLOYMENT, AND PERSONALIZATION OF REAL-TIME INTERACTIVE DIGITAL AGENTS

(71) Applicant: TWO PLATFORMS INC., Campbell, CA (US)

(72) Inventors: Abhijit Bendale, Campbell, CA (US); Bob Lian, Palo Alto, CA (US); Michael Sapienza, Mountain View, CA (US); Pranav Mistry, Saratoga, CA (US); Simon Gibbs, San Jose, CA (US)

(21) Appl. No.: 17/686,201

(22) Filed: Mar. 3, 2022

(51) Int. Cl. G06N 5/00; H04L 67/10

(52) U.S. Cl. CPC G06N 5/003; H04L 67/10

(57) ABSTRACT

A method includes receiving an input comprising multi-modal inputs such as text, audio, video, or context information from a client device associated with a user, assigning a task associated with the input to a server among a plurality of servers, determining a context response corresponding to the input based on the input and interaction history between the computing system and the user, generating meta data specifying expressions, emotions, and non-verbal and verbal gestures associated with the context response by querying a trained behavior knowledge graph, generating media content output based on the determined context response and the generated meta data, the media content output comprising of text, audio, and visual information corresponding to the determined context response in the expressions, the emotions, and the non-verbal and verbal gestures specified by the meta data, sending instructions for presenting the generated media content output to the user to the client device.

### TECHNICAL FIELD

This disclosure generally relates to machine-learning technologies, and in particular relates to hardware and software for machine-learning models for autonomously generated, deployed, and personalized digital agents.

### BACKGROUND

Artificial neural networks (ANNs), usually simply called neural networks (NNs), are computing systems vaguely inspired by the biological neural networks that constitute animal brains. An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it. The “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times. Generative Adversarial Networks (GANs) are a type of the ANNs that generate new data, such as a new image, based on input data.

### SUMMARY OF PARTICULAR EMBODIMENTS

The appended claims may serve as a summary of the invention.

### BRIEF DESCRIPTION OF THE DRAWINGS

FIG. 1 illustrates an example logical architecture for a computing system for autonomously generating media content output representing a personalized digital agent as a response to an input from a user.

FIG. 2 illustrates an example physical architecture for a computing system for autonomously generating media content output representing a personalized digital agent as a response to an input from a user.

FIG. 3 illustrates an example comparison of multi-session chats between traditional digital agents and the digital agents powered by the machine-learning-based context engine.

FIG. 4 illustrates an example architecture for the multi-encoder decoder network that utilizes information from the plurality of sources.

FIG. 5 illustrates an example scenario for updating a conversational model.

FIG. 6 illustrates an example procedure for generating a personalized response based on information from external sources.

FIG. 6A illustrates an example sentiment analysis process.

FIG. 7 illustrates an example functional architecture of the machine-learning-based media-content-generation engine.

FIG. 8 illustrates an example input and output of the machine-learning-based media-content-generation engine.

FIG. 9 illustrates an example method for autonomously generating media content output representing a personalized digital agent as a response to an input from a user.

FIG. 10 illustrates an example computer system.

### DESCRIPTION OF EXAMPLE EMBODIMENTS

Embodiments are described in sections below according to the following outline:
1. General Overview
2. Structural Overview
3. Functional Overview
4. Implementation Example - Hardware Overview

### 1. General Overview

Particular embodiments described herein relate to systems and methods for autonomously generating media content output representing a personalized digital agent as a response to an input from a user. The system described herein may comprise an Application Programming Interface (API) gateway, a load balancer, a plurality of servers responsible for generating media content output for a plurality of simultaneous inputs from users, and a plurality of autonomous workers. The plurality of servers may be horizontally scalable based on real-time loads. The responses generated by personalized digital agent can be in the form of text, audio and/or visually embodied Artificial Intelligence (AI).

The system disclosed herein is able to provide a personalized digital agent with photo-realistic visuals that are capable of conveying human-like emotions and expressions. The system is programmed to be aware of the context of the interactions (e.g., conversations) with users and are able to automatically convey emotions and expressions in real-time during such interactions. The system is further programmed with a sentiment detection mechanism that allows the agents to determine users’ emotions and respond accordingly (e.g., “you look sad today,” “you appear to be in a happy mood,” etc.). The system is also programmed with an intent detection mechanism that allows the digital agents to determine users’ intent and respond accordingly. The system is further programmed to draw from multiple external sources and past conversation history with users to provide dynamic, human-like responses to user inquiries. The system is able to communicate and switch between multiple modalities in real-time, e.g., audio (voice calls), video (face-to-face conversations). The system is also programmed to generate, maintain, and utilize a global interest map from conversation history, which may be continuously updated based on future conversations. Through the various aspects of the embodiments disclosed herein, the system is able to determine topics that are of interest to users.

In particular embodiments, a computing system on a distributed and scalable cloud platform may receive an input comprising multi-modal inputs such as text, audio, video, or any suitable context information from a client device associated with a user. The computing system may assign a task associated with the input to a server among a plurality of servers. The task associated with the input may comprise procedures for generating an output corresponding to the input. In particular embodiments, a load-balancer in the computing system may assign the task to the server. The load-balancer may perform horizontal scaling based on real-time loads of the plurality of servers.

In particular embodiments, the computing system may determine a context response corresponding to the input based on the input and interaction history between the computing system and the user using a machine-learning-based context engine. The machine-learning-based context engine may utilize a multi-encoder decoder network trained to utilize information from a plurality of sources. The multi-encoder decoder network may be trained with self-supervised adversaria from real-life conversation with source-specific conversational-reality loss functions. The plurality of sources may include two or more of the input, the interaction history, external search engines, or knowledge graphs. The information from the external search engines or the knowledge graphs may be based on one or more formulated queries. The one or more formulated queries may be formulated based on context of the input, the interaction history, or a query history of the user. The interaction history may be provided through a conversational model. To maintain the conversational model, the computing system may generate a conversational model with an initial seed data when a user interacts with the computing system for a first time. The computing system may store an interaction summary to a data store following each interaction session. The computing system may query, from the data store, the interaction summaries corresponding to previous interactions when a new input from the user arrives. The computing system may update the conversational model based on the queried interaction summaries.

In particular embodiments, the computing system may generate meta data specifying expressions, emotions, and non-verbal and verbal gestures associated with the context response by querying a trained behavior knowledge graph. The meta data may be constructed in a markup language. The markup language may be further used to bring synchronization between modalities during multi-modal communication (e.g. synchronizing audio with visually generated expressions)

In particular embodiments, the computing system may generate media content output based on the determined context response and the generated meta data using a machine-learning-based media-content-generation engine. In particular embodiments, the machine-learning-based media-content-generation engine may run on an autonomous worker among a plurality of autonomous workers. The media content output may comprise context information corresponding to the determined context response in the expressions, the emotions, and the non-verbal and verbal gestures specified by the meta data. The media content output may comprise a visually embodied AI delivering the context information in verbal and non-verbal forms. To generate the media content output, the machine-learning-based media-content-generation engine may receive text comprising the context response and the meta data from the machine-learning-based context engine. The machine-learning-based media-content-generation engine may generate audio signals corresponding to the context response using text to speech techniques. The machine-learning-based media-content-generation engine may generate facial expression parameters based on audio features collected from the generated audio signals. The machine-learning-based media-content-generation engine may generate a parametric feature representation of a face based on the facial expression parameters. The parametric feature representation may comprise information associated with geometry, scale, shape of the face, or body gestures. The machine-learning-based media-content-generation engine may generate a set of high-level modulation for the face based on the parametric feature representation of the face and the meta data. The machine-learning-based media-content-generation engine may generate a stream of video of the visually embodied AI that is synchronized with the generated audio signals. The machine-learning-based media-content-generation engine may comprise a dialog unit, an emotion unit, and a rendering unit. The dialog unit may generate (1) spoken dialog based on the context response in a pre-determined voice and (2) speech styles comprising spoken affect, intonations, and vocal gestures. The dialog unit may generate an internal representation of synchronized facial expressions and lip movements corresponding to the generated spoken dialog based on phonetics. The dialog unit may be capable of generating the internal representation of synchronized facial expressions and lip movements corresponding to the generated spoken dialog across a plurality of languages and a plurality of regional accents. The emotion unit may maintain the trained behavior knowledge graph. The rendering unit may generate the media content output based on output of the dialog unit and the meta data. Furthermore, the machine-learning-based media content-generation engine may generate body gestures such as hand movements, pointing, waving and other gestures that enhance conversational experience from incoming text and audio data.

In particular embodiments, the computing system may send instructions to the client device for presenting the generated media content output to the user.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### 2. Structural Overview

In the following description, methods and systems are described for autonomously generating media content output representing a personalized digital agent as a response to an input from a user. The systems may generate low-latency multi-modal responses via generated and stored content. The system may generate photo-realistic visual look with emotions and expressions. The emotions and expressions may be controlled with markup-language-based meta data. The digital agent may be able to provide personalized responses based on a plurality of knowledge sources, including past interaction history, long-term memory and other contextual source of information.

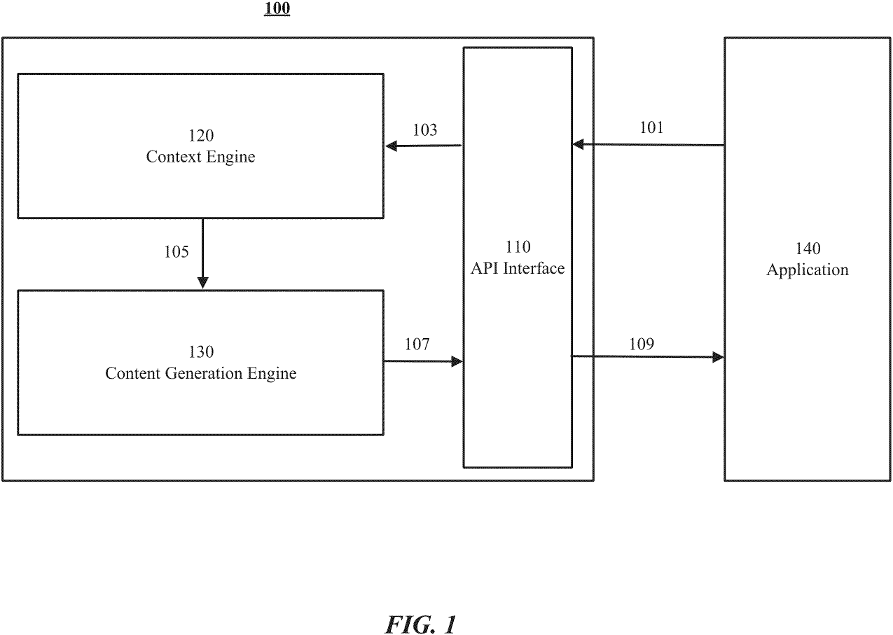

FIG. 1 illustrates an example logical architecture for a computing system for autonomously generating media content output representing a personalized digital agent as a response to an input from a user. An API interface 110 of the computing system 100 may receive a user input from a client application 140 associated with the user at step 101. The user input may comprise multi-modal inputs that include context information, along with text, audio and visual inputs depending on mode of chat (text chat, audio chat or video chat). At step 103, the API interface 110 may forward the user input to a machine-learning-based context engine 120 of the computing system 100. The machine-learning-based context engine 120 may determine a context response corresponding to the user input based on the user input and interaction history between the computing system 100 and the user. The machine-learning-based context engine 120 may also generate meta data specifying expressions, emotions, and non-verbal and verbal gestures associated with the context response by querying a trained behavior knowledge graph. At step 105, the determined context response along with the meta data is forwarded to a machine-learning-based media-content-generation engine 130 of the computing system 100. The machine-learning-based media-content-generation engine 130 may generate media content output based on the determined context response and the meta data. The media content output may comprise context information corresponding to the determined context response in the expressions, the emotions, and the non-verbal and verbal gestures specified by the meta data. At step 107, the generated media content output may be forwarded to the API interface 110. The API interface 110 may send instructions for presenting the generated media content output to the user to the client application 140 at step 109. Although this disclosure describes a particular logical architecture for autonomously generating media content output representing a personalized digital agent as a response to an input from a user, this disclosure contemplates any suitable logical architecture for autonomously generating media content output representing a personalized digital agent as a response to an input from a user.

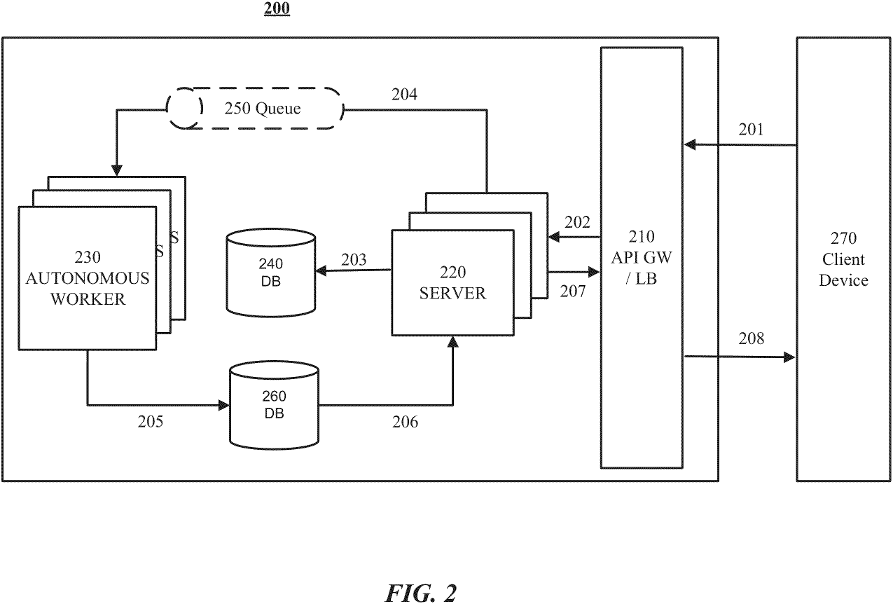

FIG. 2 illustrates an example physical architecture for a computing system for autonomously generating media content output representing a personalized digital agent as a response to an input from a user. An API gateway 210 of the computing system 200 may receive a user input from a client device 270 associated with the user at step 201. The user input may be received through representational state transfer (REST) API. A load balancer 210 collocated with the API gateway may assign a task of generating a response corresponding to the received user input to one of a plurality of servers 220 of the computing system 200 at step 202. In particular embodiments, the load balancer may be separate from the API gateway 210. The server 220 may determine a context response corresponding to the user input by processing the user input and interaction history between the computing system 220 and the user with a machine-learning-based context engine 120. The server 220 may also generate meta data specifying expressions, emotions, and non-verbal and verbal gestures associated with the context response. At step 203, the server 220 may check a first database 240 to determine whether a pre-generated media content output corresponds to the context response. When the server 220 determines that no pre-generated media content output corresponding to the context response exist, the server 220 may forward the determined context response along with the generated meta data to one of a plurality of autonomous worker 230 through a queue 250 at step 204. A scheduler associated with the queue 250 may schedule each queued job to an autonomous worker 230. The autonomous worker 230 may generate media content output based on the determined context response and the generated meta data. The media content output may comprise context information corresponding to the determined context response in the expressions, the emotions, and the non-verbal and verbal gestures specified by the meta data by using a machine-learning-based media-content-generation engine 130. At step 205, the autonomous worker 230 may store the generated media content output to a second database 260. At step 206, the server 220 may retrieve the generated media content output from the second database 260. At step 207, the server 220 may forward the media content output to the API gateway 210. At step 208, the API gateway 210 may send instructions for presenting the generated media content output to the user to the client device 270 as an API response. The API response may be a REST API response. Although this disclosure describes a particular physical architecture for autonomously generating media content output representing a personalized digital agent as a response to an input from a user, this disclosure contemplates any suitable physical architecture for autonomously generating media content output representing a personalized digital agent as a response to an input from a user.

In particular embodiments, a computing system 200 on a distributed and scalable cloud platform may receive an input comprising context information from a client device 270 associated with a user. In particular embodiments, the API gateway 210 may receive the input from the client device 270 as an API request. The API gateway 210 may be an API management tool to provide interface between client application and backend service. In particular embodiments, the API may be REST API, which is extensively considered as a standard protocol for web APIs. The computing system 200 may provide REST APIs for applications to access internal services. In particular embodiments, an extensive list of APIs may be available both for internal applications and partner integration. The computing system may assign a task associated with the input to a server among a plurality of servers 220. The task associated with the input may comprise procedures for generating an output corresponding to the input. In particular embodiments, a load-balancer 210 of the computing system 200 may assign the task to the server 220. The load-balancer 210 may perform horizontal scaling based on real-time loads of the plurality of servers 220. As an example and not by way of limitation, the computing system 200 may use a series of infrastructural components, including but not limited to servers, autonomous workers, queuing systems, databases, authentication services, or any suitable infrastructural components, to handle requests from users. A request by user/ API may be routed through the API gateway 210 to a server 220 by means of load balancers. The computing system 200 may follow serverless compute paradigm. Following an incoming request from application, the computing system 200 may treat each task independently in its own isolated compute environment. This principle may enable downstream application to have workload isolation and improved security. Different components of the computing system 200 may communicate with each other using task tokens. As tasks are isolated, the tasks may be independent of underlying compute specificity and can scale horizontally. Performing a plurality of tasks may be parallel and a large number of simultaneous requests can be fulfilled. The servers 220 may access workers 230, and databases 240, 260 to handle and fulfill incoming requests and provide responses back to the downstream applications. Depending on the task, a server 220 may either create a worker task or a database task. The worker task may involve orchestrating an autonomous worker instantiation and management for content generation. A database task may involve of query and update of database, depending on the nature of requests. Queues and messaging services may be used to handle these tasks. Queues and massaging services may also provide the computing system 200 an ability to manage and handle high-volume incoming requests with very low probability of task failure. Servers, workers, queues, and databases are continuously monitored using high performance distributed tracing system to monitor and troubleshoot production service to ensure minimum downtime. Although this disclosure describes a particular computing system on a distributed and scalable cloud platform, this disclosure contemplates any suitable computing system on a distributed and scalable cloud platform in any suitable manner.

In particular embodiments, the computing system 200 may be capable of response personalization with long-term memory and search queries. Chatbots may offer a conversational experience using artificial intelligence and natural language processing that mimic conversations with real people. A Chatbot may be as simple as basic pattern matching with a response, or the Chatbot may be a sophisticated weaving of artificial intelligence techniques with complex conversational state tracking and integration into existing business services. Traditional chatbots may be trained and evaluated on a fixed corpus with seed data and deployed in the field for answering and interacting with users. Training with a fixed corpus may lead to responses that are static and do not account for changing nature of the real-world. Furthermore, the response topics may be confined to the topics that were available in the training corpus. Finally, lack of a memory component may mean that the response topics fail to capture short-term and long-term context leading to monotonous, repetitive, and robotic agent-user interaction. In contrast, humans may engage with each other with memory, specificity and understanding of context. Building an intelligent digital agent, that can converse on broad range of topics and converse with humans coherently and engagingly has been a long-standing goal in the domains of Artificial Intelligence and Natural Language Processing. Achieve this goal may require a fundamentally different approach in terms of how conversational digital agent systems are designed, built, operated, and updated. The machine-learning-based context engine 120 may take novel approaches for conversational digital agent personalization using long term memory, context, and agent user interactions. The machine-learning-based context engine 120 may learn from seed training data to create a base conversation model. The machine-learning-based context engine 120 may have an ability to store and refer to prior conversations as well as seek additional information as required from external knowledge sources. The machine-learning-based context engine 120 may also have a capability of automatically generating queries to external knowledge sources and seeking information as required, in addition to conversational model. Furthermore, the machine-learning-based context engine 120 may learn from previous conversations and adapt and update the base conversation model with on-going interactions to generate context-aware, memory-aware, and personalized responses. Due to an explicit long-term memory module, the computing system 200 may have an ability to maintain, refer and infer from long-term multi-session conversations and provide more natural and human-like interactions. Multitude of data sources may be used to train and adapt the system, including, but not limited to, fixed corpus, conversation history, internet search engines, external knowledge bases and others.

In particular embodiments, the machine-learning-based context engine 120 may be classified into an open-domain conversational system. Conversational systems may be classified into two types: closed-domain conversational systems and open-domain conversational systems. Closed-domain conversational systems may be designed for specific domains or tasks such as flight booking, hotel reservation, customer service, technical support, and others. The closed-domain conversational systems may be specialized and optimized to answer a specific set of questions for a particular task. The closed-domain conversational systems may be trained with fixed corpus related to the task. Such systems may often lack notion of memory and be static in terms of their response. The domain of topics the closed-domain conversational systems are tuned to answer may also be limited and may not grow over time. The closed-domain conversational systems may fail to generalize to other domains beyond the ones that they were trained. Human conversations, however, may be open-domain and can span wide ranging topics. Human conversations may involve memory, long-term context, engagement, and dynamic nature of covered topics. Furthermore, human conversations may be fluid and may refer to on-going changes in the dynamic world. A goal of an open-domain digital agent is to maximize the long-term user engagement. This goal may be difficult for the closed-domain conversational systems to optimize for because different ways exist to improve engagement like providing entertainment, giving recommendations, chatting on an interesting topic, providing emotional comforting. To achieve them, the systems may be required to have deep understanding of conversational context, user’s emotional needs and generate interpersonal response with consistency, memory, and personality. These engagements need to be carried over multiple sessions while maintaining session specific context, multi-session context and user context. The closed-domain conversational systems are trained on fixed corpus with seed dataset. The extent of topics expressed may remain fixed over number of sessions. The open-domain conversational systems access previous interaction history as well as a plurality of information sources when the open-domain conversational systems prepare responses to the user. As a number of sessions increase, topics covered by the open-domain conversational system may increase, which cannot be achieved by the closed-domain conversational systems.

### 3. Functional Overview

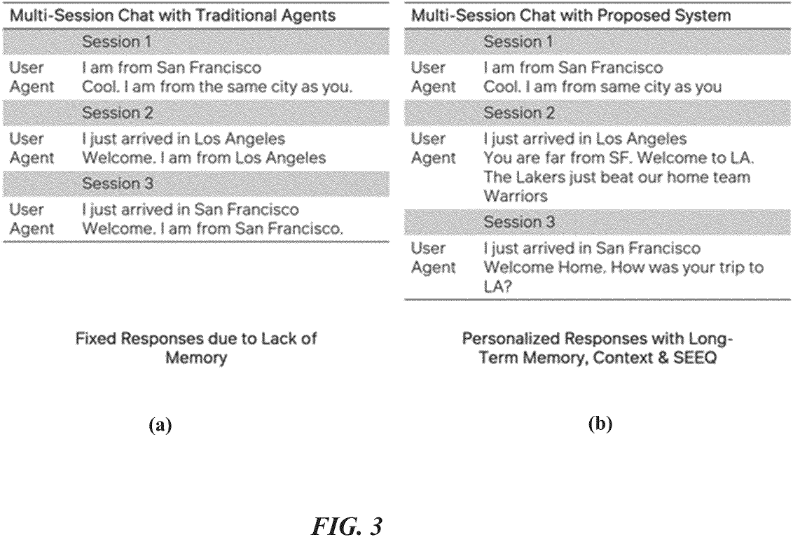

In particular embodiments, the computing system 200 may keep track of interactions between the computing system 200 and a user over multiple sessions. Traditional digital agents focus on single session chats. In single session chats, session history, session context and user context may be cleared out after the chat. When the user logs back in, the digital agent may ask a similar set of on-boarding questions over again, making the interaction highly impersonal and robotic. Personalized conversational digital agents may need to maintain state of the conversation via both short-term context as well as long-term context. Digital agents may need to engage in conversation over a length of time and capture user interest via continuous engagement. In multi-session conversations spanning days/weeks, the digital agent may need to maintain consistency of persona. Topics of conversation may change over time. Real-world is dynamic and changes over time. For example, when a person asks for the latest score of her favorite team to a digital agent, the answer may be different over multiple sessions. Thus, the digital agent may need to access to dynamic sources of information, make sense from the information and use the information in generating responses. Furthermore, an answer space between user 1 and the digital agent may be highly different from an answer space between user 2 and the digital agent, depending on the topics of conversation and overall conversation history. Traditional conversational agents lack the mechanisms to account for these changing factors of open-domain dynamic and hyper-personalized conversations. FIG. 3 illustrates an example comparison of multi-session chats between traditional digital agents and the digital agents powered by the machine-learning-based context engine. In FIG. 3, example chat session “(a)” presents a multi-session chat between a user and a traditional digital agent that does not keep track of interactions between the computing system and a user over multiple sessions. In session 1, the user indicates that she is from San Francisco. The digital agent may clear out this information after the session 1. In session 2, when the user says that she has just arrived in Los Angeles, the digital agent may not be able to relate the information that the user is currently in Los Angeles and the information that the user is from San Francisco because the latter information may have been cleared out after session 1. In session 3, the user indicates that she has arrived in San Francisco, which is her hometown. But, the digital agent may not be able to incorporate information that San Francisco is the hometown of the user when the digital agent comes up with a response. Example chat session “(b)” of FIG. 3 presents a multi-session chat between a user and a digital agent that keeps track of interactions between the computing system and a user over multiple sessions. The machine-learning-based context engine 120 may generate the responses of this digital agent. In session 1, the user indicates that she is from San Francisco. When session 1 finishes, the digital agent may store such information. In session 2, when the user says that she has just arrived in Los Angeles, the digital agent may be able to determine that the user is away from her hometown based on the stored information. When session 2 finishes, the digital agent may store the information that the user has visited Los Angeles. When the user indicates that she has arrived in San Francisco in session 3, the digital agent may be able to come up with a response based on information that the user’s hometown is San Francisco, and that the user has visited Los Angeles. Although this disclosure describes keeping track of interactions between the computing system and a user over multiple sessions in a particular manner, this disclosure contemplates keeping track of interactions between the computing system and a user over multiple sessions in any suitable manner.

In particular embodiments, the computing system 200 may determine a context response corresponding to the input based on the input and interaction history between the computing system and the user using a machine-learning-based context engine 120. The machine-learning-based context engine 120 may utilize a multi-encoder decoder network trained to utilize information from a plurality of sources. A self-supervised adversarial approach may be applied to train the multi-encoder decoder network from real-life conversational data. In this process, clean (ideal) data as well as incorrect data may be presented to the system, so that the network may become robust for handling difficult examples. In order to infer information from plurality of sources such as memory, search engines, knowledge graphs, context, during the training process the system may need to have learnt from these sources. A loss function used to train this network may be termed as conversational-reality loss and goal during the training process may be to minimize the loss in realism of generated conversations from the system. The self-supervised adversarial training may enable the multi-encoder decoder network to converge much faster than existing transformer methods leading to more efficient training and compute times. The multi-encoder decoder network model runtime inference may tap into the open internet for updated and current information. This may bring contextual conversation capability that a pre-trained transformer model lacks and may be what differentiates its replies from that of pre-trained transformers. Although this disclosure describes a particular machine-learning-based context engine, this disclosure contemplates any suitable machine-learning-based context engine.

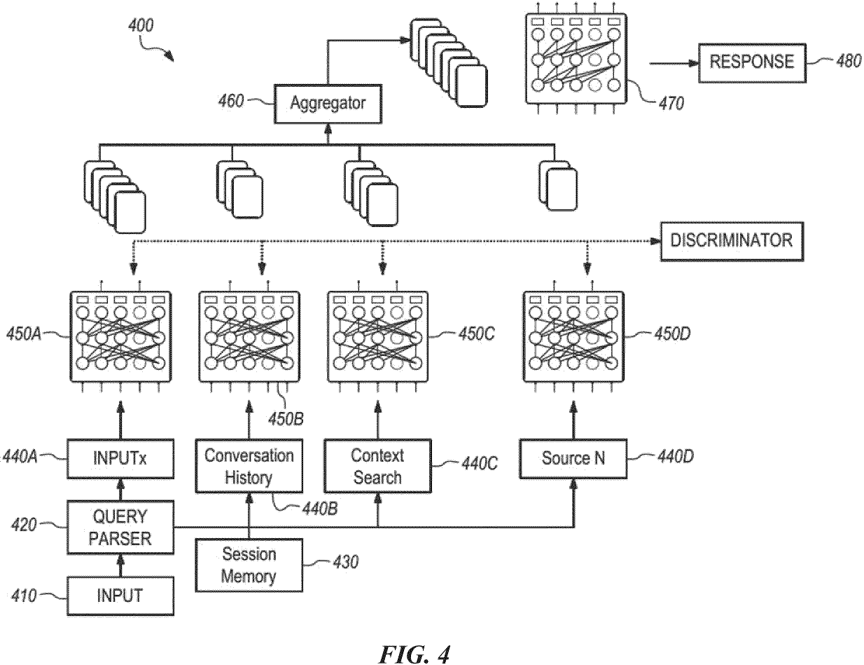

In particular embodiments, the plurality of sources utilized by a multi-encoder decoder network may include two or more of the input, the interaction history, external search engines, or knowledge graphs. The information from the external search engines or the knowledge graphs may be based on one or more formulated queries. The one or more formulated queries may be formulated based on context of the input, the interaction history, or a query history of the user. FIG. 4 illustrates an example architecture for the multi-encoder decoder network that utilizes information from the plurality of sources. When the machine-learning-based context engine 120 receives an input 410 from the user, a query parser 420 of the machine-learning-based context engine 120 may formulate one or more queries for one or more of the plurality of sources. The one or more queries may be formulated based on context of the input 410, the interaction history between the computing system 200 and the user or query history of the user stored in session memory 430. Information from one or more sources 440A, 440B, 440C, and 440D may be encoded by corresponding encoders 450A, 450B, 450C, and 450D. The information from the one or more sources 440A, 440B, 440C, and 440D may be queried based on the one or more formulated queries. An aggregator 460 of the multi-encoder decoder network 400 may aggregate latent representations produced by the encoders 450A, 450B, 450C, and 450D. The decoder 470 may process the aggregated latent representation to produce a response 480 corresponding to the input 410. Although this disclosure describes a multi-encoder decoder network that utilizes information from a plurality of sources in a particular manner, this disclosure contemplates a multi-encoder decoder network that utilizes information from a plurality of sources in any suitable manner.

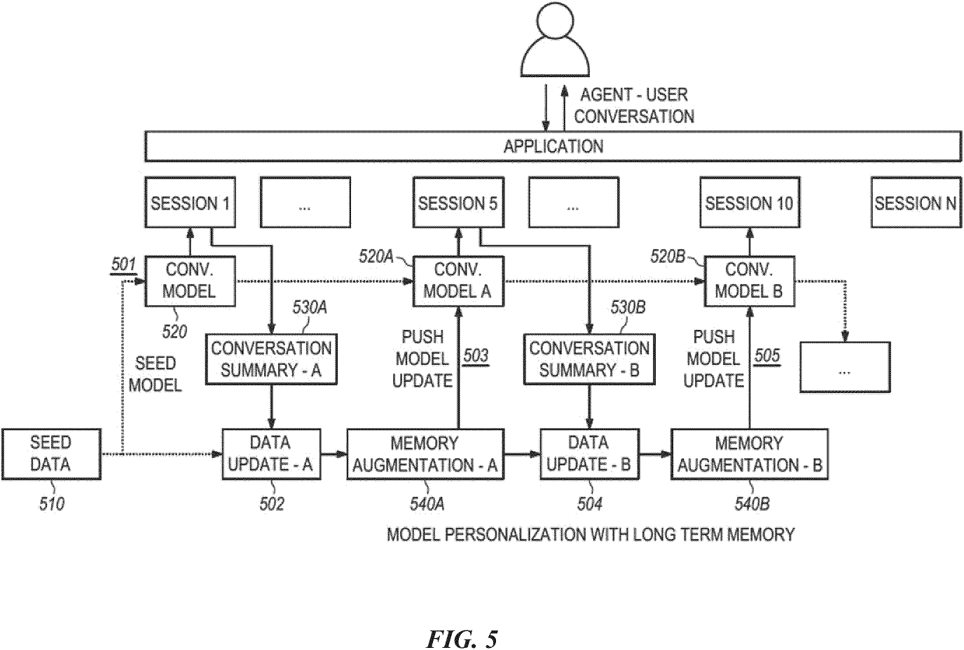

In particular embodiments, the interaction history may be provided through a conversational model. To maintain the conversational model, the computing system may generate a conversational model with an initial seed data when a user interacts with the computing system for a first time. The computing system may store an interaction summary to a data store following each interaction session. The computing system may query, from the data store, the interaction summaries corresponding to previous interactions when a new input from the user arrives. The computing system may update the conversational model based on the queried interaction summaries. FIG. 5 illustrates an example scenario for updating a conversational model. When a new user interacts with the computing system 200 for a first time by sending a first input, the machine-learning-based context engine 120 may generate a conversational model 520 for the user using a seed data 510 at step 501. At the end of session 1, the machine-learning-based context engine 120 may generate an interaction summary 530A. The machine-learning-based context engine 120 may extract high level features from raw conversational data to understand the category and topics of the conversation. Salient features/topics of the conversation may be stored in memory in form of interaction summary 530A. The interaction summary may be referred to as a conversation summary. The generated interaction summary may be stored to a data store at step 502. When a second input from the user arrives, the machine-learning-based context engine 120 may query information 540A relevant to the second input from the stored interaction summary. The machine-learning-based context engine 120 may update the context model with the queried information 540A at step 503. The updated context model 520A may be used for generating a response corresponding to the second input from the user. At the end of the session, the machine-learning-based context engine 120 may generate an interaction summary 530B. At step 504, the machine-learning-based context engine 120 may update the stored interaction summaries with the newly generated interaction summary 530B. Again, when a third input from the user arrives, the machine-learning-based context engine 120 may query information 540B relevant to the third input from the stored interaction summaries. The machine-learning-based context engine 120 may update the context model with the queried information 540B at step 505. The updated context model 520B may be used for generating a response corresponding to the third input from the user. Each user may have her own profile and interaction history. Even though all users might start from similar conversational models, the digital agent may be highly personalized with respective interaction histories over a period. Although this disclosure describes generating and maintaining a conversational model that provides the interaction history between the computing system and the user in a particular manner, this disclosure contemplates generating and maintaining a conversational model that provides the interaction history between the computing system and the user in any suitable manner.

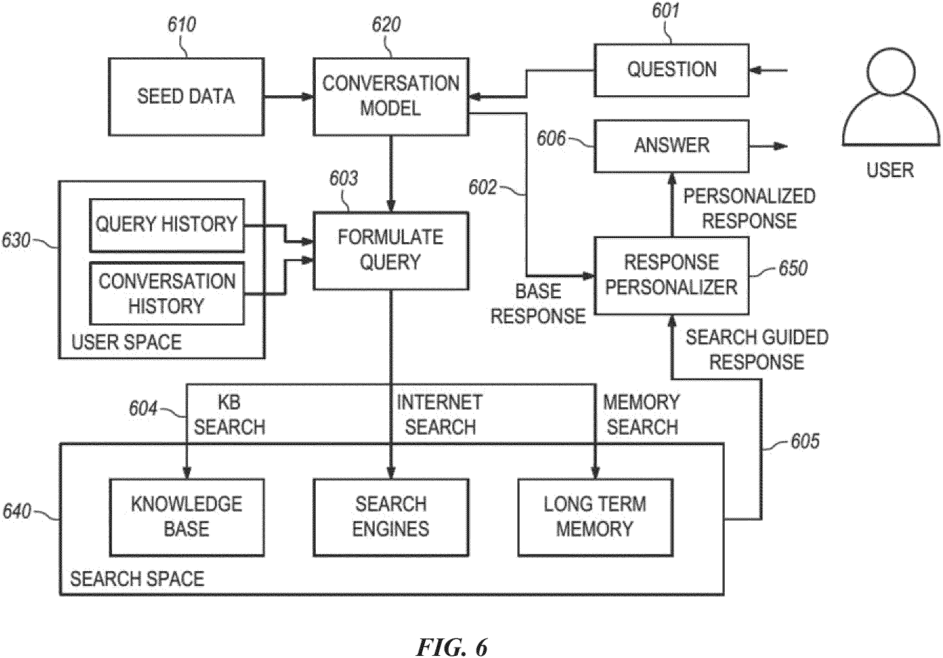

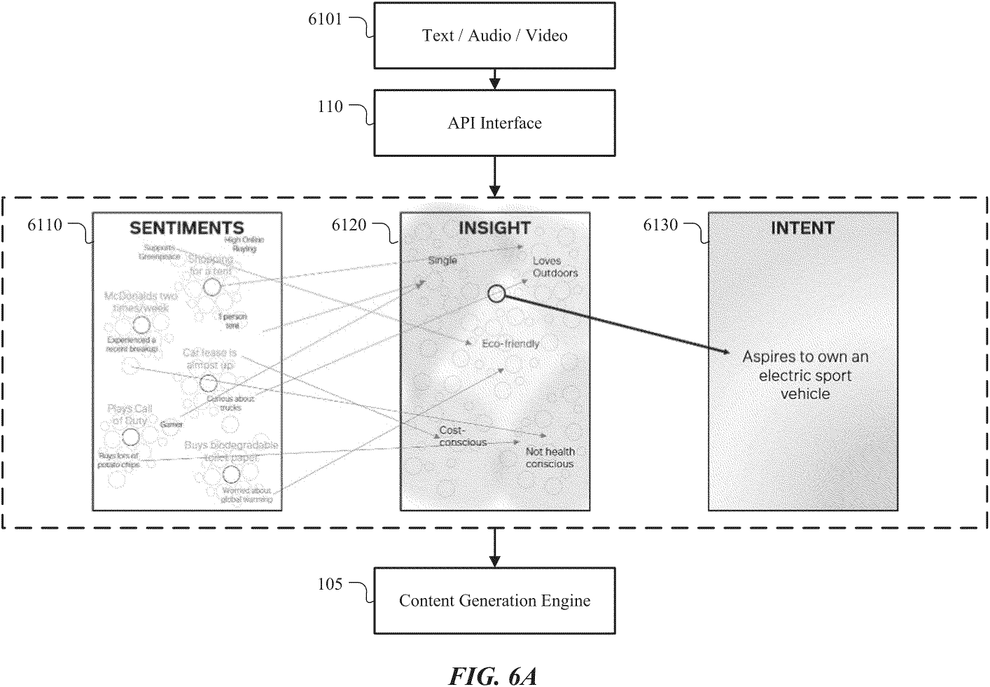

In particular embodiments, the machine-learning-based context engine 120 may personalize a response based on information from external sources such as such as search engines, knowledge graphs or other sources of data. One major problem with traditional fixed corpus conversational models may be that the traditional conversational models are static in terms of generated responses, regardless of the changing world. The traditional conversational models lack the mechanisms to incorporate the latest information from external knowledge sources, augment this information with generated responses and create a relevant response with most up to date information about the real-world. The machine-learning-based context engine 120 may personalize the conversational model with external knowledge sources such as search engines, knowledge graphs or other sources of data. The machine-learning-based context engine 120 may start with seed data creating an initial model of a digital agent. When the user asks a question to the digital agent, the machine-learning-based context engine 120 may formulate one or more queries for one or more external knowledge sources such as a search engine or knowledge graph by understanding the context of the question. While formulating the queries, the machine-learning-based context engine 120 may consider the expressed context of the question as well as long-term context from previous interactions (long-term memory). Based on the formulated query, the machine-learning-based context engine 120 may search relevant sources and create a search guided response. The machine-learning-based context engine 120 may aggregate the base response from the conversational model and the search guided response. The machine-learning-based context engine 120 may generate a final personalized response for the user. With this approach, the machine-learning-based context engine 120 may be able to access the latest information available in external knowledge sources without being constrained to the seed data that the conversational model was trained on. Multi-Encoder architecture of the machine-learning-based context engine 120 may be used to process multiple sources of information. FIG. 6 illustrates an example procedure for generating a personalized response based on information from external sources. The machine-learning-based context engine 120 may create an initial conversational model 620 based on seed data 610. When an input 601, such as a question, from the user arrives, the machine-learning-based context engine 120 may generate a based response 602 using the conversational model 620. The machine-learning-based context engine 120 may also formulate one or more queries at step 603 based on context of the input and interaction history or query history stored in the data store 630. At step 604, the machine-learning-based context engine 120 may search relevant information from one or more external knowledge sources 640. The machine-learning-based context engine 120 may generate a search guided response 605 using the multi-encoder decoder network. A response personalizer 650 of the machine-learning-based context engine 120 may generate a personalized response 606 for the given input 601 based on the base response 602 and the search guided response 605. Although this disclosure describes personalizing a response based on information from external sources in a particular manner, this disclosure contemplates personalizing a response based on information from external sources in any suitable manner.

In particular embodiments, the machine-learning-based context engine 120 may extract information associated with intent of the user from the user input. The incoming text and audio may contain rich information about topics of interest, likes/dislikes and long-term behavioral patterns. Audio and video modalities may contain information about user affect, behavior and instantaneous reactions. These behavioral features may help with understanding of intent of the user, that is used by context engine to generate emotions and expression tags. From the incoming text, speech or video received at step 103, topics, sentiments and other behavioral features may be extracted. For each user, a template in the form of user-graph may be maintained whereby conversation topics, relationship between topics, sentiments are stored. These stored templates may be used (either during the session or in future sessions) to understand the underlying intent in the conversations.

In particular embodiments, incoming data-stream may undergo sentiment analysis process which may be used to add content in sentiment templates and insight templates. These templates may be used to generate global interest map for a user. During sentiment analysis process, we analyze the incoming text and extract topics of conversation, sentiments that are expressed (e.g. happy, sad, joy, anger etc.) using machine learning models. The extracted topics may be mapped into high-level topics which are entered onto template for a specific user. As a user talks on various topics over the span of multiple sessions, the templates can be analyzed to extract high-level insights about the user’s behavior and intent. This information is passed to downstream content generation engine 130 at step 105 for placing and generating contextual emotions.

FIG. 6A illustrates an example sentiment analysis process. During a particular conversation session between a user and agent, the user might be talking about visit to national park, during another session the user might be talking about travel arrangements, yet in another session the user might be talking with agent about purchasing of shoes and buying an electric car and so on. The user input 6101 in various forms may be delivered to the machine-learning-based context engine 120 through the API interface 110. From these conversations, the machine-learning-based context engine 120 may generate sentiment template 6110, insight template 6120 and global interest map 6130. Aggregating this information over successive session may help understand overall intent and behavior of the user, which can further help the machine-learning-based context engine 120. The aggregated information may be passed to the content generation engine 130.

In particular embodiments, the machine-learning-based context engine 120 of the computing system 200 may generate meta data specifying expressions, emotions, and non-verbal and verbal gestures associated with the context response by querying a trained behavior knowledge graph. The meta data may be constructed in a markup language. Although this disclosure describes generating meta data specifying expressions, emotions, and non-verbal and verbal gestures associated with the context response in a particular manner, this disclosure contemplates generating meta data specifying expressions, emotions, and non-verbal and verbal gestures associated with the context response in any suitable manner.

In particular embodiments, the computing system 200 may generate media content output based on the determined context response and the generated meta data using a machine-learning-based media-content-generation engine 130. In particular embodiments, the machine-learning-based media-content-generation engine 130 may run on an autonomous worker among a plurality of autonomous workers 230. The media content output may comprise context information corresponding to the determined context response in the expressions, the emotions, and the non-verbal and verbal gestures specified by the meta data. The media content output may comprise a visually embodied AI delivering the context information in verbal and non-verbal forms. Although this disclosure describes generating media content output based on the determined context response and the generated meta data in a particular manner, this disclosure contemplates generating media content output based on the determined context response and the generated meta data in any suitable manner.

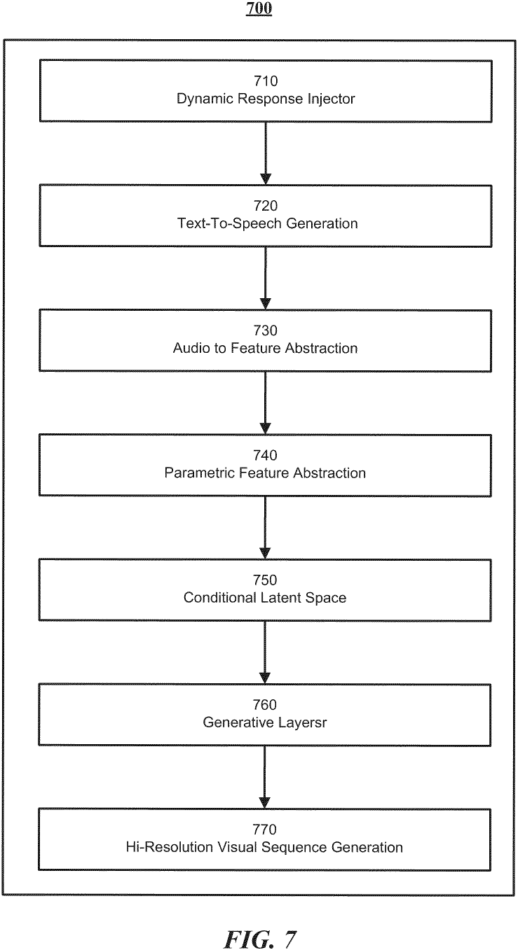

In particular embodiments, the machine-learning-based media-content-generation engine 130 may receive text comprising the context response and the meta data from the machine-learning-based context engine 120 in order to generate the media content output. FIG. 7 illustrates an example functional architecture 700 of the machine-learning-based media-content-generation engine 130. The dynamic response injector layer 710 of the machine-learning-based media-content-generation engine 130 may receive text input from the machine-learning-based context engine 120. The text may comprise the context response along with the meta data. The meta data may be constructed in a markup language. The meta data may specify expressions, emotions, and non-verbal and verbal gestures associated with the context response. FIG. 7 is intended as an illustration at the functional level at which skilled persons, in the art to which this disclosure pertains, communicate with one another to describe and implement algorithms using programming. The flow diagram is not intended to illustrate every instruction, method object or sub-step that would be needed to program every aspect of a working program, but are provided at the same functional level of illustration that is normally used at the high level of skill in this art to communicate the basis of developing working programs.

In particular embodiments, the machine-learning-based media-content-generation engine 130 may generate audio signals corresponding to the context response using text to speech techniques. The machine-learning-based media-content-generation engine 130 may generate timed audio signals as output. The generated audio may contain desired variations in affect, pitch, style, accent, or any suitable variations based on the meta data. As an example and not by way of limitation, continuing with an example illustrated in FIG. 7, the text-to-speech generation layer 720 of the machine-learning-based media-content-generation engine 130 may generate audio signals corresponding to the context response using text to speech techniques. The generated audio may contain desired variations in affect, pitch, style, accent, or any suitable variations based on the meta data. Although this disclosure describes generating audio signals corresponding to the context response using text to speech techniques in a particular manner, this disclosure contemplates generating audio signals corresponding to the context response using text to speech techniques in any suitable manner.

In particular embodiments, the machine-learning-based media-content-generation engine 130 may generate facial expression parameters based on audio features collected from the generated audio signals. As an example and not by way of limitation, continuing with an example illustrated in FIG. 7, the audio to feature abstraction layer 730 of the machine-learning-based media-content-generation engine 130 may take audio stream from the text-to-speech generation layer 720 as input. The audio stream may get converted to low-level audio features that the machine-learning-based media-content-generation engine 130 can understand. The machine-learning-based media-content-generation engine 130 may transform audio features into facial expression parameters. Although this disclosure describes generating facial expression parameters based on audio features collected from the generated audio signals in a particular manner, this disclosure contemplates generating facial expression parameters based on audio features collected from the generated audio signals in any suitable manner.

In particular embodiments, the machine-learning-based media-content-generation engine 130 may generate a parametric feature representation of a face based on the facial expression parameters. The parametric feature representation may comprise information associated with geometry, scale, shape of the face, or body gestures. As an example and not by way of limitation, continuing with an example illustrated in FIG. 7, the parametric feature abstraction layer 740 of the machine-learning-based media-content-generation engine 130 may take the facial expression parameters generated by the audio to feature abstraction layer 730 as input. The parametric feature abstraction layer 740 may generate a parametric feature representation of a face that comprises information associated with geometry, scale, shape of the face, or body gestures. Although this disclosure describes generating a parametric feature representation of a face based on the facial expression parameters in a particular manner, this disclosure contemplates generating a parametric feature representation of a face based on the facial expression parameters in any suitable manner.

In particular embodiments, the machine-learning-based media-content-generation engine 130 may generate a set of high-level modulation for the face based on the parametric feature representation of the face and the meta data. As an example and not by way of limitation, continuing with an example illustrated in FIG. 7, the conditional latent space layer 750 of the machine-learning-based media-content-generation engine 130 may generate high level modulation for face such as look, hair color, head position, expression, behavior, and others based on the meta data from the dynamic response injector layer 710. Although this disclosure describes generating a set of high-level modulation for the face based on the parametric feature representation of the face and the meta data in a particular manner, this disclosure contemplates generating a set of high-level modulation for the face based on the parametric feature representation of the face and the meta data in any suitable manner.

In particular embodiments, the machine-learning-based media-content-generation engine 130 may generate pixel images corresponding to frames based on the parametric feature representation of the face and the set of high-level modulation for the face. As an example and not by way of limitation, continuing with an example illustrated in FIG. 7, the generative layer 760 of the machine-learning-based media-content-generation engine 130 may generate pixel images corresponding to frames based on the parametric feature representation of the face and the set of high-level modulation for the face. Although this disclosure describes generating pixel images corresponding to frames based on the parametric feature representation of the face and the set of high-level modulation for the face in a particular manner, this disclosure contemplates generating pixel images corresponding to frames based on the parametric feature representation of the face and the set of high-level modulation for the face in any suitable manner.

In particular embodiments, the machine-learning-based media-content-generation engine 130 may generate a stream of video of the visually embodied AI that is synchronized with the generated audio signals. As an example and not by way of limitation, continuing with an example illustrated in FIG. 7, the Hi-resolution visual sequence generation layer 770 may generate a stream of video of the visually embodied AI that is synchronized with the generated audio signals. Although this disclosure describes generating a stream of video of the visually embodied AI that is synchronized with the generated audio signals in a particular manner, this disclosure contemplates generating a stream of video of the visually embodied AI that is synchronized with the generated audio signals in any suitable manner.

In particular embodiments, the machine-learning-based media-content-generation engine 130 may comprise a dialog unit, an emotion unit, and a rendering unit. The machine-learning-based media-content-generation engine 130 may provide speech, emotions, and appearance for generated digital agents to provide holistic personas. The machine-learning-based media-content-generation engine 130 may receive inputs from the machine-learning-based context engine 120 about intents, reactions, and context. The machine-learning-based media-content-generation engine 130 uses these inputs to generate a human persona with look, behavior, and speech. The machine-learning-based media-content-generation engine 130 may generate a feed that can be consumed by downstream applications at scale. Although this disclosure describes particular components of the machine-learning-based media-content-generation engine, this disclosure contemplates any suitable components of the machine-learning-based media-content-generation engine.

In particular embodiments, the dialog unit may generate (1) spoken dialog based on the context response in a pre-determined voice and (2) speech styles comprising spoken affect, intonations, and vocal gestures. The dialog unit may generate an internal representation of synchronized facial expressions and lip movements corresponding to the generated spoken dialog based on phonetics.

In particular embodiments, the dialog unit of the machine-learning-based media-content-generation engine 130 may be responsible for generating speech and intermediate representations that other units within the machine-learning-based media-content-generation engine 130 can interpret and consume. The dialog unit may transform the input text to spoken dialog with natural and human-like voice. The dialog unit may generate speech with the required voice, spoken style (e.g. casual, formal etc.), with spoken affect, intonations and vocal gestures specified by the meta data. The dialog unit may take the generated speech a step further and translate the generated speech into synchronized facial expressions, lip movements and speech by means of an internal representation that can be consumed by the rendering unit to generate visual looks. The dialog unit may be based on phonetics, instead of features corresponding to a specific language. Thus, the dialog unit may be language agnostic and easily extensible to support a wide range of languages. The dialog unit may map the incoming text to synchronized lip movements with affect, intonations, pauses, speaking styles across wide range of languages. The dialog unit may be compatible with World Wide Web Consortium (WWWC)′s Extensible Markup Language (XML) based speech markup language, which may provide precise control and customization as needed by downstream applications in terms of pitch, volume, prosody, speaking styles, or any suitable variations. The dialog unit may handle and adjust generated lip synchronization seamlessly to account for these changes across languages. Although this disclosure describes the dialog unit of the machine-learning-based media-content-generation engine in a particular manner, this disclosure contemplates the dialog unit of the machine-learning-based media-content-generation engine in any suitable manner. The dialog unit can scale across multiple languages and generates vocal expressions and affect to aid with generated speech.

In particular embodiments, the emotion unit of the machine-learning-based media-content-generation engine 130 may maintain the trained behavior knowledge graph. The emotion unit may be responsible for generating emotions, expressions, and non-verbal and verbal gestures in controllable and scriptable manner at scale based on context signals. The emotion unit may work within the machine-learning-based media-content-generation engine 130 in conjunction with the dialog unit and the rendering unit to generate human-like expressions and emotions. At the core, the emotion unit may comprise a large behavior knowledge graph generated by learning, organizing, and indexing visual data collected from large corpus of individuals during data collection process. The behavior knowledge graph may be queried to generate facial expressions, emotions, body gestures with fidelity and precise control. These queries may be typed or generated autonomously from the machine-learning-based context engine 120 based on underlying context and reactions that need to be generated. The ability to script queries and generate expressions autonomously provide the machine-learning-based media-content-generation engine 130 to generate emotions at scale. Markup-language-based meta data may allow standardized queries and facilitate communication between various units within the machine-learning-based media-content-generation engine 130. Although this disclosure describes the emotion unit of the machine-learning-based media-content-generation engine in a particular manner, this disclosure contemplates the emotion unit of the machine-learning-based media-content-generation engine in any suitable manner.

In particular embodiments, the rendering unit of the machine-learning-based media-content-generation engine 130 may generate the media content output based on output of the dialog unit and the meta data. The rendering unit may receive input from the dialog unit comprising speech and intermediate representations (lip synchronization, affect, vocal gestures etc.) specified in the meta data, and input from the emotion unit comprising facial expressions, emotions and gestures specified in the meta data. The rendering unit may combine these inputs and synthesize photo-realistic digital persona. The rendering unit may consist of significantly optimized algorithms from emerging areas of technologies of computer vision, neural rendering, computer graphics and others. A series of deep neural networks may infer and interpret the input parameters from the emotion unit and the dialog unit and render high quality digital persona in real-time. The rendering unit may be robust to support wide ranging facial expressions, emotions, gestures, and scenarios. Furthermore, the generated look may be customized to provide hyper-personal experience by providing control over facial appearance, makeup, hair color, clothes, or any suitable features. The customization may be taken the step further to control scene properties like lighting, viewing angle, eye-gaze, or any suitable properties to provide personal connection during face-to-face interactions with the digital agent. Although this disclosure describes the rendering unit of the machine-learning-based media-content-generation engine in a particular manner, this disclosure contemplates the rendering unit of the machine-learning-based media-content-generation engine in any suitable manner. Furthermore, the rendering unit is capable of generating other visual and scene elements such as objects, background, look customizations and other scene properties.

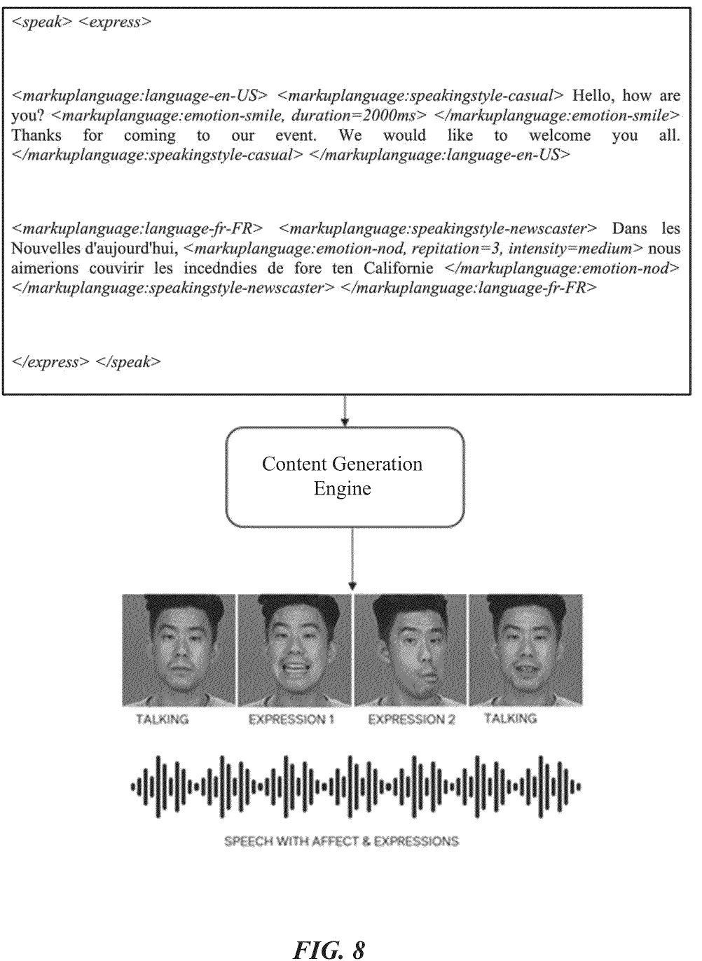

In particular embodiments, the markup-language-based meta data may provide a language-agnostic way to markup text for generation of speech, video and video with expressions and emotions. A number of benefits of the markup-language-based meta data may be observed when synthesizing audio and video from a given text. The meta data may allow consistency of generation from one piece of text to wide ranging audio and videos. The meta data may also provide a language agnostic way to generate emotions, expressions, and gestures in generated video. Furthermore, the meta data may enable to add duration for a particular expression along with the intensity of the generated expression. The meta data may also enable sharing of the script between different machines and ensure reproducibility. Finally, the meta data may make the generated script human readable. In particular embodiments, the markup-language-based meta data may be XML based markup language and has ability to modulate and control both speech as well as videos. The markup-language-based meta data may specify pitch, contour, pitch range, rate, duration, volume, affect, style, accent, or any suitable features for speech. The markup-language-based meta data may specify intensity (low, medium, high), duration, dual (speech & video), repetitions, or any suitable features for affect controls. The markup-language-based meta data may also specify expression, duration, emotion, facial gestures, body gestures, speaking style, speaking domain, multi-person gestures, eye-gaze, head-position, or any suitable feature for video. FIG. 8 illustrates an example input and output of the machine-learning-based media-content-generation engine. Input to the machine-learning-based media-content-generation engine 130 may be text comprising context information in one or more languages along with markup-language-based meta data. In the example illustrated in FIG. 8, the meta data specifies the language to be spoken, speaking style, emotional expressions and their duration, number of repetitions, or intensity. Based on the provided input, the machine-learning-based media-content-generation engine 130 may generate media content output comprising context information in the expressions, the emotions, and the non-verbal and verbal gestures specified by the meta data in the input text. Although this disclosure describes the markup-language-based meta data in a particular manner, this disclosure contemplates the markup-language-based meta data in any suitable manner.

The computing system 200 may send instructions to the client device for presenting the generated media content output to the user. The API gateway 210 of the computing system 200 may send instructions to the client device 270 as a response to an API request. In particular embodiments, the API may be REST API. Although this disclosure describes sending instructions to the client device for presenting the generated media content output to the user in a particular manner, this disclosure contemplates sending instructions to the client device for presenting the generated media content output to the user in any suitable manner.

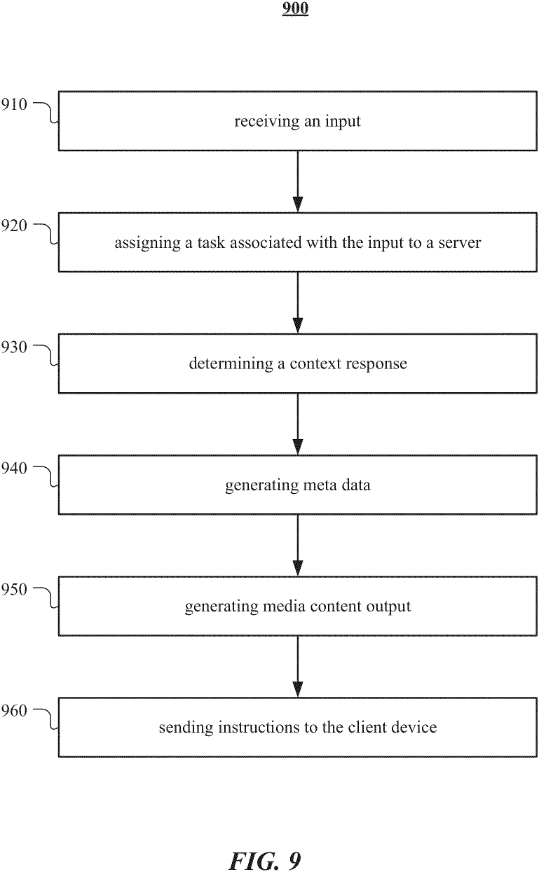

FIG. 9 illustrates an example method 900 for autonomously generating media content output representing a personalized digital agent as a response to an input from a user. The method may begin at step 910, where the computing system 200 may receive an input comprising context information from a client device associated with a user. At step 920, the computing system 200 may assign a task associated with the input to a server among a plurality of servers. At step 930, a machine-learning-based context engine of the computing system 200 may determine a context response corresponding to the input based on the input and interaction history between the computing system and the user. At step 940, the computing system 200 may generate meta data specifying expressions, emotions, and non-verbal and verbal gestures associated with the context response by querying a trained behavior knowledge graph. At step 950, a machine-learning-based media-content-generation engine of the computing system 200 may generate media content output based on the determined context response and the generated meta data, the media content output comprising context information corresponding to the determined context response in the expressions, the emotions, and the non-verbal and verbal gestures specified by the meta data. At step 960, the computing system 200 may send instructions for presenting the generated media content output to the user to the client device. Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for autonomously generating media content output representing a personalized digital agent as a response to an input from a user including the particular steps of the method of FIG. 9, this disclosure contemplates any suitable method for autonomously generating media content output representing a visually embodied AI as a response to an input from a user including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

### 4. Implementation Example - Hardware Overview

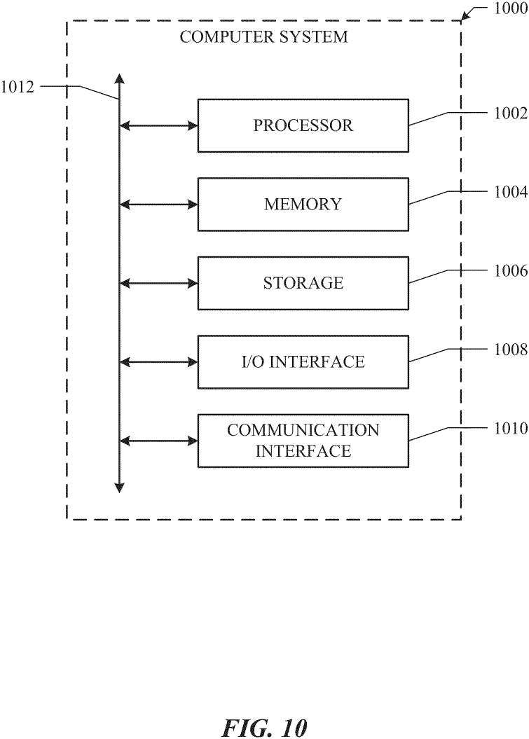

FIG. 10 illustrates an example computer system 1000. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks. Where appropriate, one or more computer systems 1000 may perform without substantial spatial or temporal limitation one or more steps of one or more methods described or illustrated herein. As an example and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere). One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 1004, where appropriate. Although this disclosure describes and illustrates particular memory, this disclosure contemplates any suitable memory.

In particular embodiments, storage 1006 includes mass storage for data or instructions. As an example and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006. Although this disclosure describes and illustrates particular storage, this disclosure contemplates any suitable storage.

In particular embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it. As an example and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system on a distributed and scalable cloud platform:
receiving an input comprising multi-modal inputs from a client device associated with a user;
assigning a task associated with the input to a server among a plurality of servers;
determining, by a machine-learning-based context engine, a context response corresponding to the input based on the input and interaction history between the computing system and the user;
generating meta data specifying expressions, emotions, and non-verbal and verbal gestures associated with the context response by querying a trained behavior knowledge graph;
generating, by a machine-learning-based media-content-generation engine, media content output based on the determined context response and the generated meta data, the media content output comprising of text, audio, and visual information corresponding to the determined context response in the expressions, the emotions, and the non-verbal and verbal gestures specified by the meta data;
sending, to the client device, instructions for presenting the generated media content output to the user.

2. The method of claim 1, the machine-learning-based context engine utilizing a multi-encoder decoder network trained to utilize information from a plurality of sources.

3. The method of claim 2, the multi-encoder decoder network being trained with self-supervised adversaria from real-life conversation with source-specific conversational-reality loss functions.

4. The method of claim 2, the plurality of sources including two or more of the input, the interaction history, external search engines, or knowledge graphs.

5. The method of claim 4, the interaction history being provided through a conversational model.

6. The method of claim 5, the conversational model being maintained by:
generating a conversational model with an initial seed data when a user interacts with the computing system for a first time;
storing an interaction summary to a data store following each interaction session;
querying, when a new input from the user arrives, from the data store, the interaction summaries corresponding to previous interactions;
updating the conversational model based on the queried interaction summaries.

7. The method of claim 4, the information from the external search engines or the knowledge graphs being based on one or more formulated queries.

8. The method of claim 7, the one or more formulated queries being formulated based on context of the input, the interaction history, or a query history of the user.

9. The method of claim 1, the media content output comprising a visually embodied AI delivering the context information in verbal and non-verbal forms.

10. The method of claim 9, the generating the media content output comprising:
receiving, from the machine-learning-based context engine, text comprising the context response and the meta data;
generating audio signals corresponding to the context response using text to speech techniques;
generating facial expression parameters based on audio features collected from the generated audio signals;
generating a parametric feature representation of a face based on the facial expression parameters, the parametric feature representation comprising information associated with geometry, scale, shape of the face, or body gestures;
generating a set of high-level modulation for the face based on the parametric feature representation of the face and the meta data;
generating a stream of video of the visually embodied AI that is synchronized with the generated audio signals.

11. The method of claim 1, the machine-learning-based media-content-generation engine comprising a dialog unit, an emotion unit, and a rendering unit.

12. The method of claim 11, the dialog unit generating (1) spoken dialog based on the context response in a pre-determined voice and (2) speech styles comprising spoken affect, intonations, and vocal gestures.

13. The method of claim 12, the dialog unit generating an internal representation of synchronized facial expressions and lip movements corresponding to the generated spoken dialog based on phonetics.

14. The method of claim 13, the dialog unit being capable of generating the internal representation of synchronized facial expressions and lip movements corresponding to the generated spoken dialog across a plurality of languages and a plurality of regional accents.

15. The method of claim 11, the trained behavior knowledge graph being maintained by the emotion unit.

16. The method of claim 11, the media content output being generated by the rendering unit based on output of the dialog unit and the meta data.

17. The method of claim 1, the machine-learning-based media-content-generation engine running on an autonomous worker among a plurality of autonomous workers.

18. The method of claim 1, the assigning the task to the server being done by a load-balancer, and the load-balancer performing horizontal scaling based on current loads of the plurality of servers.

19. One or more computer-readable non-transitory storage media embodying software that is operable when executed to:
receive an input comprising multi-modal inputs from a client device associated with a user;
assign a task associated with the input to a server among a plurality of servers;
determine, by a machine-learning-based context engine, a context response corresponding to the input based on the input and interaction history between the computing system and the user;
generate meta data specifying expressions, emotions, and non-verbal and verbal gestures associated with the context response by querying a trained behavior knowledge graph;
generate, by a machine-learning-based media-content-generation engine, media content output based on the determined context response and the generated meta data, the media content output comprising of text, audio, and visual information corresponding to the determined context response in the expressions, the emotions, and the non-verbal and verbal gestures specified by the meta data;
send, to the client device, instructions for presenting the generated media content output to the user.

20. A system comprising: one or more processors; and a non-transitory memory coupled to the processors comprising instructions executable by the processors, the processors operable when executing the instructions to:
receive an input comprising multi-modal inputs from a client device associated with a user;
assign a task associated with the input to a server among a plurality of servers;
determine, by a machine-learning-based context engine, a context response corresponding to the input based on the input and interaction history between the computing system and the user;
generate meta data specifying expressions, emotions, and non-verbal and verbal gestures associated with the context response by querying a trained behavior knowledge graph;
generate, by a machine-learning-based media-content-generation engine, media content output based on the determined context response and the generated meta data, the media content output comprising of text, audio, and visual information corresponding to the determined context response in the expressions, the emotions, and the non-verbal and verbal gestures specified by the meta data;
send, to the client device, instructions for presenting the generated media content output to the user.
